(19) United States
(12) Patent Application Publication
(10) Pub. No.: US 2004/0008453 A1
(43) Pub. Date: Jan. 15, 2004

(54) Magnetic layer system and a component comprising such a layer system

(76) Inventor: Xiliang Nie, Englewood, CO (US)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/381,168

(22) PCT Filed: Sep. 19, 2001
(86) PCT No.: PCT/DE01/03631

(30) Foreign Application Priority Data
Sep. 21, 2000 (DE) 100467822

(51) Int. Cl. G11B 5/127; G11B 5/33

(52) U.S. Cl. 360/324.11

(57) ABSTRACT

The invention relates to a method for producing a new generation of giant magnetoresistance (GMR) sensors and tunnel magnetoresistance (TMR) sensors. According to the invention, a thin-film fixing layer is produced, for example, from a 5d transition metal (W, Rd, Os, Ir, Pt) or from a 4d transition metal (Pd, Rh, Ru) having a high magnetocrystalline anisotropy. Said thin-film fixing layer fixes the direction of magnetization of the fixed layer (3d ferromagnetic transition metals). A moment filter can be constructed with which the effectiveness of GMR and TMR sensors can be increased.

### TECHNICAL FIELD

The invention relates to a magnetic layer system and a component having such a layer system, especially a component utilizing a magnetic resistance (MR) or a tunnel magnetic resistance (TMR), as for example a magnetic sensor for a magnetic storage [memory].

### STATE OF THE ART

Different materials have an electrical conductivity which reacts especially sensitively to an applied magnetic field.

This phenomenon is used in many magnetic sensors and in magnetic working storage (MRAM—Magnetic Random Access Memories) on the basis of the giant magnetic resistance (GMR) and tunnel magnetic resistance (TMR).

Typically such sensors encompass multiple ferromagnetic layers which are separated by nonmagnetic layers. In the absence of an external magnetic field, the ferromagnetic layers can be magnetized in opposite directions through an interlayer exchange coupling. An applied external magnetic field then gives rise to a parallel orientation of the magnetization directions in the ferromagnetic layers. Since the resistance depends upon the magnetization direction, an external magnetic field which alters the magnetic configuration can be simply detected by a resistance change. It is however required to hold the energy difference between the different magnetization directions as small as possible so as to enable the detection of weak magnetic fields. This can be achieved by a nonmagnetic interlayer between the ferromagnetic layers.

It is known that in the field of magnetic data storage with fixed plate computer memories, sensors of the GMR type (having the following advantages) are increasingly displacing previously used sensors. The GMR type sensors have several advantages over sensors which use anisotropic magnetic resistance (AMR).

GMR sensors use advantageously the entire angle information. While oppositely oriented magnetic fields are not distinguishable from AMR sensors and give the same signal in colinear and noncolinearly oriented regions, with GMR sensors colinear and noncolinear orientations give different electrical resistances.

A further advantage of GMR sensors over AMR sensors is that they provide a comparatively stronger signal.

Also of advantage is the fact that the GMR effect is a boundary layer effect. This means that a GMR sensor can be much thinner than a corresponding sensor of the AMR type.

It is also known that the tunnel magnetic resistance (TMR) effect has been studied in conjunction with the possibility of use in the magnetic operating storage under development for future applications. These are known under the designation magnetic random access memories (MRAM) and can replace the currently used semiconductor memories.

In principle the GMR effect is also suitable for that purpose. The TMR effect however has the clear advantage of a greater intrinsic resistance of the sensor. In MRAMs this is significant because of the higher resistance of the connecting conductors between the storage element and the processor.

Both GMR sensors and TMR sensors are comprised typically of one free magnetic layer, an intermediate layer and a ferromagnetic layer whose direction of magnetization is fixed by an antiferromagnetic layer bounding it.

The free layer is usually also a ferromagnetic layer and is designated as the sensor layer. The intermediate layer encompasses advantageously elements such as Cu, AG, Au, Mn and Cr in the GMR type of sensor and insulators in the TMR type.

The free layer is usually also a ferromagnetic layer and is designated as the sensor layer. The intermediate layer encompasses advantageously elements such as Cu, Ag, Au, Mn and Cr in the GMR type of sensor and insulators in the TMR type.

The function of the layer system resides in that the magnetization direction of the sensor layer reacts to external magnetic fields while the fixed ferromagnetic layer, however, remains uninfluenced thereby. The magnetization direction of the fixed layer is maintained through the strong antiferromagnetic interaction between the fixed ferromagnetic layer and the neighboring antiferromagnetic layer.

A problem in the fabrication of such a layer system is that of finding suitable materials which are proper for the antiferromagnetically coupled fixing layer.

A further problem is the production of the requisite differently magnetic orientations (colinear and noncolinear). In that respect it is noted that the magnetization direction of the sensor layer is usually tied to the magnetization direction of the fixed layer because of the wide ranging interconnection between the layers. This accounts disadvantageously for the only small efficiency (less than 20% in the case of a GMR and less than 50% in the case of a TMR).

### OBJECT AND SOLUTION

The object of the invention is to provide a layer system and a magnetic component having such a layer system which enables improved fixing of the magnetization direction of a ferromagnetic layer by comparison with the state of the art.

Further it is an object of the invention to provide a magnetic component which has only a small interaction between a fixed ferromagnetic layer and a further ferromagnetic sensor layer.

The objects of the invention are achieved with a layer system having the features of the main claim as well as a magnetic component with the features of the first auxiliary claim. The further auxiliary claims teach further advantageous configurations of the invention.

Further advantageous embodiments are given in the subordinate claims which are dependent thereon.

### DESCRIPTION OF THE INVENTION

According to claim 1, the layer system according to the invention encompasses a fixing layer and a ferromagnetic layer neighboring it. This ferromagnetic layer has typically 3d-transition metals or an alloy or a multilayer system of 3d-transition metals. The 3d-transition metals include especially Fe, Ni and Co.

For fixing the magnetization direction, the neighboring ferromagnetic layer encompasses the fixing layer of 4d-transition elements or 5d-transition elements.

It has been determined, surprisingly, that with a material combination of 3d-transition elements of the ferromagnetic layer and 4d- or 5d-transition metals of the fixing layer, the 3d-transition metals determine the magnitude of the magnetic moment while the magnetization direction is determined by the 4d- or 5d-transition metals.

The ferromagnetic layer which is comprised of the 3d-transition metals is thus fixed by the high magnetocrystalline anisotropic energy (MAE) of the 4d- or 5d-transition metals of the fixing layer. Up to now it has been customary to provide a strong antiferromagnetic coupling through the use of materials which are known from the state of the art. The magnetocrystalline anisotropic energy of the layers according to the invention produce an advantageous coupling (fixing) of the magnetization direction of the fixed ferromagnetic layer.

The magnetization direction runs in general along a preferred direction in the crystalline sense and/or is determined by the macroscopic structure of a magnetic object. This characteristic is termed magnetocrystalline anisotropy. The energy which is necessary to change the orientation from a state of less energy to that of the highest energy is the anisotropic energy.

This anisotropic energy results from relativistic effects, especially the dipole-dipole and the spin-orbit interaction. The magnetic anisotropy expressed in magnetic units is in the order of 0.01 to 10 MJ/m³.

Especially advantageously suitable elements of the 4d-transition elements or the fixing layer, according to claim 2, are the elements palladium (Pd), rhodium (Rh) and ruthenium (Ru).

Advantageously suitable 5d-transition elements according to claim 3 are the elements tungsten (W), rhenium (Re), osmium (Os), iridium (Ir) and platinum (Pt).

Both the 4d- or 5d-transition elements have a high magnetocrystalline anisotropic energy (MAE) and thus enable in a simple manner the fixing of the magnetization direction of the neighboring ferroelectric layer.

In an advantageous configuration, the 4d- or 5d-transition metal-containing fixing layers according to claim 4 is configured as a thin layer. By “thin layer” we understand a layer with a layer thickness of 1 to 10 atomic layers.

Especially advantageously according to the invention is that the fixing layer according to claim 5 is configured as a monolayer. A monolayer of a 4d- or 5d-transition element can serve to fix the magnetization direction of the ferromagnetic layer. This embodiment is especially material conserving and enables a very compact construction of the fixing layer. Advantageously magnetic components which are correspondingly compact can be produced which encompass these layer systems.

Through the use of 5d-transition metals (or also several 4d-transition metals) for the fixing layer, the fabrication process is simplified because already with several atomic layers the 5d-transition metal (or also several 4d-transition metals) suffices to fix the magnetization direction of the fixed layer (for example a thin film of 3d-transition metals).

The magnetic anisotropy in the material combination of 3d- and 4d- or 5d-transition metals is very high because of the large spin orbital constants and the small spin splitting.

The anisotropy reacts in that case uniformly sensitively on the fine structure of the charge density of the 4d- or 5d-transition element in the region of the Fermi energy.

Through the combination according to the invention of a ferromagnetic layer incorporating a 3d-transition element and fixing layer incorporating a 4d- or 5d-transition element, the thickness and direction of the magnetocrystalline anisotropy of the fixing layer can be set.

The theory underlying the invention is based upon exact calculations of the component of the spin-orbit interaction in the magnetic field. This contribution of the spin-orbit interaction to the magnetic anisotropy is especially great at the surface and is dominating for the magnetic anisotropy in thin films. The induced magnetocrystalline anisostropy of 5d-transition metals (and several 4d-transition metals) is large enough to fix the magnetization direction of the fixed layer. Thus interaction between the sensor layer and the fixed layer is advantageously very small.

Different magnetic configurations (colinear and noncolinear sensor layers and fixed lay rs) can be produced simply by appropriate choice of the material magnetization direction of the sensor layer is then independent from the magnetization direction of the fixed layer as long as the intermediate layer is sufficiently thick. By sufficiently thick, a thickness which is especially greater than 1.0 nm should be understood. This means that because of the high magnetocrystalline anisostropy energy the 5d-transition metals, there is no interaction between the sensor layer and the fixed layer.

Another use [of the invention] is the increase in the efficiency of the GMR effect and the TMR effect. This obtains in use of a moment filter. A moment filter allows the polarized d-electrons to pass through the GMR and TMR arrangement but is however unpenetrable to unpolarized s and p electrons.

In an advantageous configuration of the component according to the invention, the magnetocrystalline anisotropic energy of the fixing layer (of 5d-transition metals or also several 4d-transition metals) amounts to about 10 to 20 meV. This is about 100 times more than the magnetocrystalline anisostropic energy of the sensor layer (thin film of 3d-transition metal). These higher energies dominate the magnetocrystalline anisotropic energies of the fixed layer and thus hold their magnetization direction fixed.

### DESCRIPTION OF THE DRAWINGS

FIG. 1: A layer structure for a magnetic sensor according to the invention with a fixing layer of 5d-transition elements. This embodiment has one fixing layer. The magnetization direction of the sensor layer and the fixed layer are shown by corresponding vector graphics.

FIG. 2: A layer structure for a magnetic sensor according to the invention with a fixing layer of 5d-transition elements. This embodiment has two fixing layers. Here as well the magnetization direction of the sensor layer and the fixed layer are shown by corresponding vector graphics.

In these arrangements (FIG. 1 and FIG. 2) the sensor layers 1 are not coupled to the fixed layers 3 so that the magnetization directions of the sensor layers 1 and the fixed layers 3 can be different and can be simply provided as colinear or noncolinear arrangements.

FIG. 3: A periodic arrangement of a layer structure according to the invention after FIG. 1 for a practical magnetic sensor.

FIG. 4: A periodic arrangement of a layer structure according to the invention after FIG. 2 for a practical magnetic sensor.

### Exemplary Embodiments

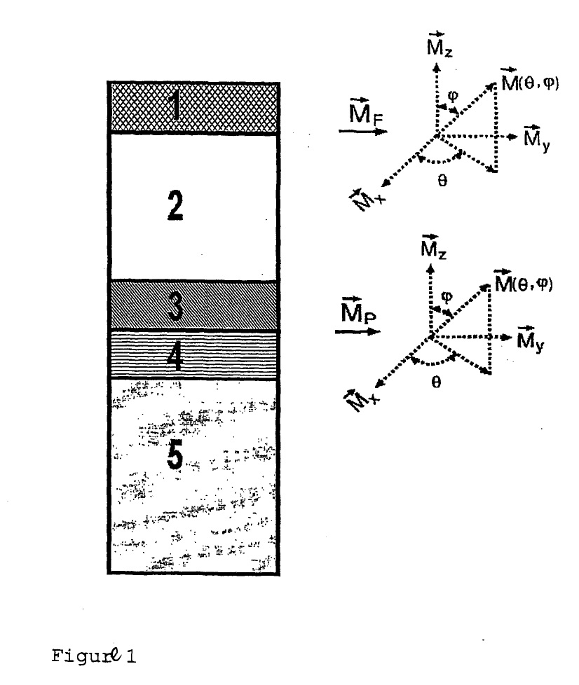

As is shown in FIG. 1 for a single GMR sensor (or TMR sensor), there is a fixed layer 3 (of 3d-transition metal) in an atom layer directly adjacent the fixing layer 4 of a 5d-transition metal of several or also of several 4d-transition metals. The fixing layer 4 is comprised advantageously either of a single atomic layer, a thin film, an alloy or also a multilayer system. In the here illustrated embodiment, the fixed layer is composed only from several individual layers of atoms because otherwise the high magnetic anisotropic energy would be too weak. There are various magnetic configurations which are possible, like, for example, Fe for the sensor layer 1 and a single layer of Fe atoms on W for the fixed layer 3. The nonlinear orientation comes about because the sensor layer 1 (MAE about 0.1 meV) lies perpendicular to the plane with the higher magnetic anisotropy while the fixed layer 3 with about 2.0 meV MAE lies in the plane. The colinear configuration is created when for the sensor layer 1 Co is used instead of Fe.

In principle, the combinations of magnetization directions (M_{F}) and (Mₚ) between sensor layer 1 and fixing layer 3 can be established in optional combinations as has been shown in the vector graphics of FIG. 1, by a corresponding selection of the combination of elements.

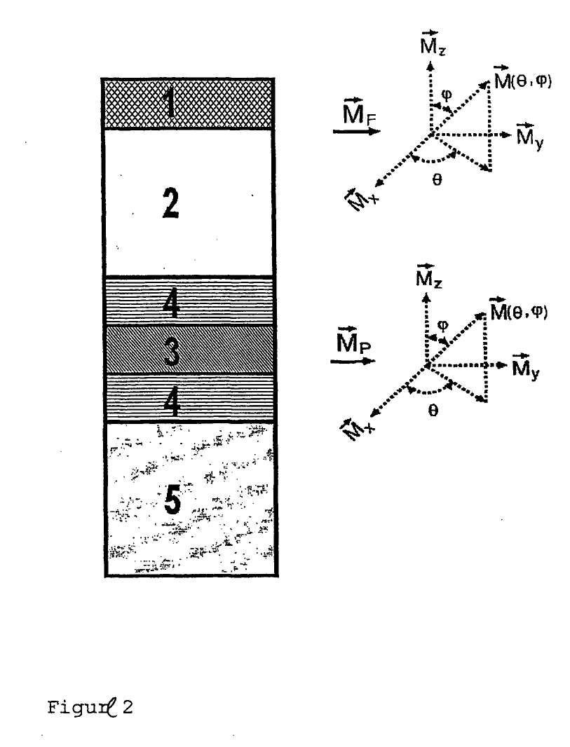

A further advantageous configuration is illustrated in FIG. 2 and is comprised of a sandwich arrangement (multiple layer) encompassing a fixing layer 4, a fixed layer 3 and a further fixing layer 4. In this embodiment the fixed layer 3 can be composed of an individual atom layer as well as from a thick film. The fixing layer 4 however need not be thick (and especially can have fewer than 5 atomic layers). The magnetocrystalline anisotropic energy of the fixed layer 3 is here higher than in FIG. 1 so that the interlayer interaction is negligibly small as for very thin intermediate layer 2.

With the described arrangements, a moment filter can be used to increase the efficiency of the GMR effect and the TMR effect. Thus materials are so combined with one another that the field of state density is in the region of the Fermi energy and dependent upon the moment. For example, a material can be chosen whose S and p state densities near the Fermi energy are lower while the d state density there is however high so that only the d state participates in a current.

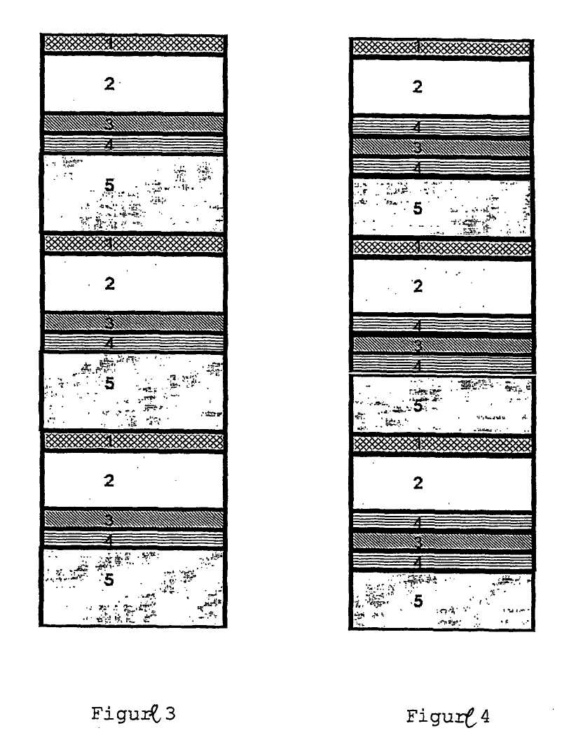

The actual GMR sensor and TMR sensor is comprised of an arrangement of many individual GMR sensors or TMR sensors as has been indicated in FIGS. 3 and 4. In the concrete embodiment, each of the 5d-transition metals (W, Re, Os, Ir, Pt) can be used and also each of the 4d-transition metals (Pd, Rh, Ru) is possible as the fixing layer.

In one arrangement as has been illustrated in FIGS. 1 and 2, the layer arrangement comprises aside from the fixing layer 4, a substrate 5 and a decoupling layer 2.

The substrate 5 can also be a layer system (multilayer) including a noble metal (Cu, Ag, Au), a 3d-transition metal, a 4d-transition metal or also a 5d-transition metal. For the decoupling layer 2, which frequently has been indicated also as an intermediate layer, preferably noble metals (Cu, Ag, Au) or also insulators can be employed. Not all 3d-, 4d- and 5d-transition metals are suitable for use as the decoupling layer 2. An artisan is however capable of finding suitable combinations for a given problem setting.

The magnetization of the sensor layer 1 (M_{F}) depends only upon the magnetization of the fixed layer 3 (Mₚ%). The magnetization of the sensor layer 1 (Mₚ) comes from weak spun-orbit interaction of the 3d-transition metal state. With sensors which comprise a combination of 3d-transition metals (fixed layer) and 5d-transition metals (fixing layer), the 3d-transition metal determines the magnetization of the magnetic moment while the magnetization direction is determined based upon the strength of the spun-orbit interaction of the 5d-transition metal. These constructions differ completely from conventional GMR materials and TMR materials in which the fixed layer is fixed by antiferromagnetic coupling.

### Legends to the FIGS. 1 to 4:

1 Ferromagnetic layer (sensor layer)

2 Intermediate layer

3 Ferromagnetic layer (fixed layer)

4 Fixing layer according to the invention

5 Substrate

\vec{M}_{F} Magnetization direction of the sensor layer 1

\vec{M}ₚ Magnetization direction of the fixed layer 3

\vec{M}ₓ Magnetization in the x direction

\vec{M}_{y} Magnetization in the y direction

\vec{M}_{z} Magnetization in the z direction

\vec{M}(θ,φ) Magnetization direction in terms of the space angles θ and φ.

1. A layer system encompassing a ferromagnetic layer containing a 3d-transition metal and at least one fixing layer bounding on the 3d-transition metal layer, characterized in that the fixing layer has 4d- or 5d-transition elements.

2. A layer system according to the preceding claim with a fixing layer encompassing at least one element of the group (Pd, Ph, Ru).

3. A layer system according to the claim 1 with a fixing layer encompassing at least one element of the group (W, Re, Os, Ir and Pt).

4. A layer system according to one of the preceding claims with a fixing layer which is an alloy of 4d- or 5d-transition elements.

5. A layer system according to one of the preceding claims in which a fixing layer comprises a multilayer system.

6. A layer system according to one of the preceding claims whereby the fixing layer is configured as a thin layer.

7. A layer system according to one of the preceding claims whereby the fixing layer is configured as a thin layer.

8. A layer system according to one of the preceding claims, characterized by a magnetocrystalline anisotropy of the fixing layer in the region of 1 to 100 meV, especially from 10 to 20 meV.

9. A magnetic component with a layer system according to one of the preceding claims 1 to 8.

10. A magnetic component according to claim 9 with a second ferromagnetic layer.

11. A magnetic component according to one of the preceding claims 9 to 10, characterized in that the fixing layer is comprised of a 4d- or 5d-transition element encompassing a sandwich layer.

12. A magnetic component according to one of the preceding claims 9 to 11, characterized in that the second ferromagnetic layer is configured as a monolayer.

13. A magnetic component according to one of the preceding claims 9 to 12, characterized in that in the layer system two fixing layers are arranged neighboringly to the first ferromagnetic layer.

14. A moment filter with a layer system according to one of claims 1 to 8.

15. A magnetic sensor with a layer system according to one of the claims 1 to 8.

16. A GMR sensor as the magnetic sensor according to the preceding claim 15.

17. A TMR sensor as the magnetic sensor according to the preceding claim 15.

18. A magnetic operating memory with a layer system according to one of the claims 1 to 8.
